(19) United States
(12) Patent Application Publication
(10) Pub. No.: US 2023/0129350 A1
(43) Pub. Date: Apr. 27, 2023

(54) SECTION-BASED MUSIC SIMILARITY SEARCHING

(71) Applicant: Adobe Inc., San Jose, CA (US)

(72) Inventors: Nicholas J. BRYAN, Belmont, CA (US); Justin SALAMON, San Francisco, CA (US)

(73) Assignee: Adobe Inc., San Jose, CA (US)

(21) Appl. No.: 17/742,318

(22) Filed: May 11, 2022

Related U.S. Application Data
(60) Provisional application No. 63/271,690, filed on Oct. 25, 2021.

(51) Int. Cl. G06F 16/683; G06F 16/632; G06F 16/635; G06F 16/64

(52) U.S. Cl. CPC G06F 16/683; G06F 16/632; G06F 16/635; G06F 16/64

(57) ABSTRACT

Embodiments are disclosed for performing a section-based, within-song music similarity search by an audio recommendation system. In particular, in one or more embodiments, the disclosed systems and methods comprise receiving an input including an audio sequence and a request to determine similar audio sequences to the audio sequence from a pre-processed audio catalog, analyzing the audio sequence to generate an audio embedding for the audio sequence, querying a pre-processed audio catalog to retrieve audio embeddings for catalog audio sequences at different time resolutions, generating a set of candidate audio sequences from the pre-processed audio catalog based on the audio embedding for the audio sequence, and providing the set of candidate audio sequences.

### CROSS-REFERENCE TO RELATED APPLICATIONS

This application claims the benefit of U.S. Provisional Application No. 63/271,690, filed Oct. 25, 2021, which is hereby incorporated by reference.

### BACKGROUND

Music is essential for creating high-quality media content, including movies, films, social media content, advertisements, podcasts, radio shows, and more. Finding the right music to match companion content is crucial to setting the desired feeling of the media content. Music similarity searching is the task of finding the most similar sounding music recordings to an input audio sequence from within a database of audio content. Given that music can have multiple notions of similarity and musical style can vary dramatically over the course of a song (e.g., changes in mood, instrumentation, tempo, etc.), music similarity searching presents several challenges.

Some existing solutions use text-based search with keywords such as “happy” and “corporate.” However, searching based on descriptions of an audio sequence can be too board and subjective. Further, these existing solutions can generate large search results and users may have to listen to dozens or hundreds of audio sequences before finding the right track.

### SUMMARY

Introduced here are techniques/technologies that allow an audio recommendation system to perform section-based, within-song music similarity searching. The audio recommendation system can find similar matching audio sequences to an input audio sequence, as well as find similar matching sections or segments within each matching audio sequence. The audio recommendation system can receive an audio sequence as an input and analyze the audio sequence to generate an audio embedding representing the audio sequence. The audio recommendation system can then identify the most similar content that matches the submitted audio sequence.

In particular, in one or more embodiments, an audio recommendation system can search for similar audio sequences across multiple time resolutions of recordings (e.g., 3-second segments, 10-second segments, whole-song segments, and/or other larger or smaller time resolutions). The audio recommendation system can build search data structures that correspond to the different time resolutions per audio sequence by extracting features on a short time resolution, then combine the embeddings together to construct feature embeddings associated with longer time resolutions. The audio recommendation system then finds audio sequences that are both globally similar across the entire audio sequence and more precisely similar to a specific segment within each audio sequence using a multi-pass search algorithm where a pool of similar whole-song matches (e.g., top 1000 similar audio sequences) are identified and then re-ranked based on finding the best matching segments within each of the matching audio sequence.

In some embodiments, the audio recommendation system uses variable time length audio embeddings based on determining musically motivated segments (e.g., intro, verse, chorus, etc.) of the audio sequence instead of audio embeddings for fixed time resolutions. The audio recommendation system uses an automatic audio sectioning algorithm per song to identify the musically motivated segments, builds a search index that corresponds to the automatically sectioned content with variable lengths, and uses the search index with the multi-pass search algorithm to identify the most closely matching audio sequences.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings

in which:

FIG. 1 illustrates a diagram of a process of performing a section-based, within-song music similarity search in accordance with one or more embodiments;

FIG. 2 illustrates a diagram of a process of processing an audio catalog using a section-based analysis in accordance with one or more embodiments;

FIG. 3 illustrates an example result of processing an audio sequence using fixed time segments in accordance with one or more embodiments;

FIG. 4 illustrates an example result of processing an audio sequence using content-based variable time segments in accordance with one or more embodiments;

FIG. 5 illustrates an example search results interface 600 in accordance with one or more embodiments.

FIG. 6 illustrates an example musical attributes filtering interface in accordance with one or more embodiments;

FIG. 7 illustrates a schematic diagram of an audio recommendation system in accordance with one or more embodiments;

FIG. 8 illustrates a flowchart of a series of acts in a method of performing a section-based, within-song music similarity search by an audio recommendation system in accordance with one or more embodiments;

FIG. 9 illustrates a flowchart of a series of acts in a method of processing catalog audio sequences to generate section-level audio embeddings by an audio recommendation system in accordance with one or more embodiments;

FIG. 10 illustrates a schematic diagram of an exemplary environment in which the audio recommendation system can operate in accordance with one or more embodiments; and

FIG. 11 illustrates a block diagram of an exemplary computing device in accordance with one or more embodiments.

### DETAILED DESCRIPTION

One or more embodiments of the present disclosure include an audio recommendation system for performing section-based, within-song music similarity searching. Simple music similarity searches can generate recommendations based on high level descriptions of an input audio sequence and catalog audio sequences. For example, in one existing solution, music can be recommended based on matching user-defined characteristics of a song or audio sequence (e.g., “happy,” “sad,” “corporate,” etc.) or genre description (e.g., rock, heavy metal, rap, etc.). The search results can then be presented to the user. However, as search results are based on global descriptors of the audio sequences, these existing solutions may not know which section of a matching audio sequence is the most similar to the input audio. This can lead to the user listening to the matching song from the beginning, which could sound very different to the input audio, giving the impression of poor or inaccurate search results and creating a frustrating experience for the user.

To address these issues, after receiving an input audio sequence, the audio recommendation system analyzes the input audio sequences to generate an audio embedding representing the features of the input audio sequence. The audio recommendation system then queries a pre-processed audio catalog to retrieve audio embeddings for catalog audio sequences, where each catalog audio sequence is associated with a plurality of audio embeddings representing the catalog audio sequence at different time resolutions. The audio recommendation system then performs a multi-pass or iterative process by comparing the audio embedding for the input audio sequence against song-level audio embeddings for the catalog audio sequences. After determining a set of candidate audio sequences representing a subset of the catalog audio sequences closest in similarity to the input audio sequence, the audio recommendation system uses segment or section-level audio embeddings for the set of candidate audio sequences to determine sections within the set of candidate audio sequences that most closely match the input audio sequence. The set of candidate audio sequences is re-ranked based on this determination and the re-ranked set of candidate audio sequences can be provided.

By performing section-based, within-song musical similarity searching, the embodiments described herein provide a significant increase in search speed and scalability. For example, by first performing a song-level comparison using a song-level audio embeddings, and then a section-level comparison using section-level audio embeddings, the audio recommendation system can more quickly cull an audio catalog to identify the most relevant audio sequences.

Further, because the audio recommendation system can determine the most similar matching section or segment of each candidate audio sequence, a playhead can be set to start directly at the most similar section of the candidate audio sequence most similar to the input audio sequence. This enables the user to immediately audition the most relevant segment/content of each audio sequence in the search result.

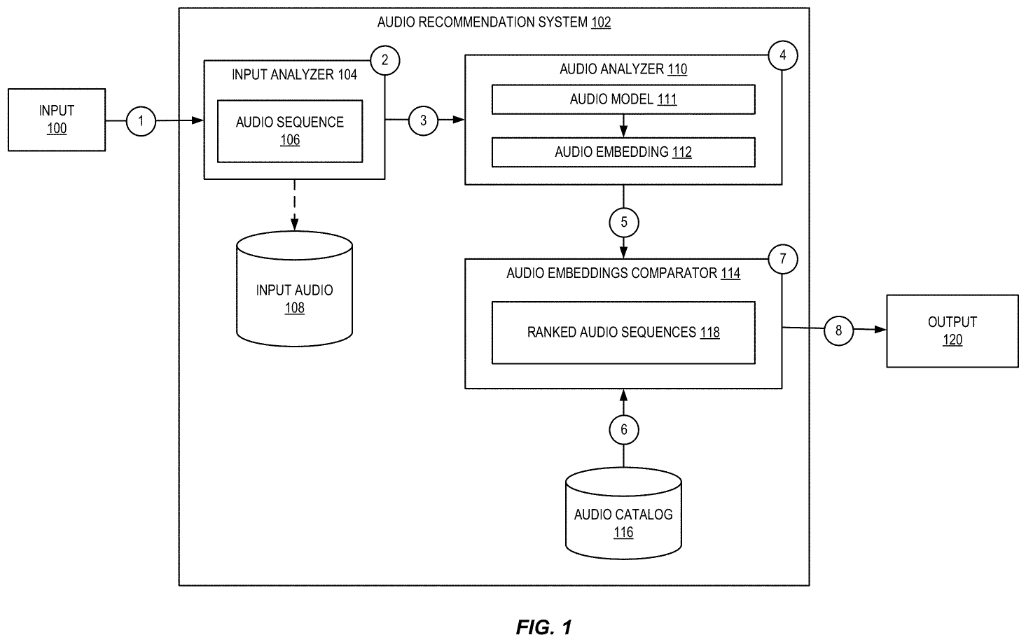

FIG. 1 illustrates a diagram of a process of performing a section-based, within-song music similarity search in accordance with one or more embodiments. As shown in FIG. 1, in one or more embodiments, an audio recommendation system 102 receives input 100 as part of a request to perform a section-based, within-song music similarity search, as shown at numeral 1. In one or more embodiments, the input 100 includes at least an audio sequence. For example, the audio recommendation system 102 receives the input 100 from a user via a computing device. In one example, a user may select files including the audio in an application. In another example, a user may submit files including the audio sequence, or information indicating the location of the audio sequence (e.g., file location, URL, etc.), to a web service or an application configured to receive audio sequences as inputs. The audio sequence can also be a portion selected from a longer audio sequence. For example, after providing the audio sequence to the application, the application can present an interface to the user to select a portion of the longer audio sequence. In one or more embodiments, the audio recommendation system 102 includes an input analyzer 104 that receives the input 100.

In one or more embodiments, the input analyzer 104 analyzes the input 100, as shown at numeral 2. In one or more embodiments, the input analyzer 104 analyzes the audio sequence to extract or determine audio sequence 106. In one or more embodiments, the input analyzer 104 can extract the audio sequence 106 from the input 100 as a raw audio waveform or in any suitable audio format. In one or more embodiments, the input 100 can also include information indicating a selection of a portion of the audio sequence 106, and in response, the input analyzer 110 can extract or clip the selected portion of the audio sequence 106.

After extracting the audio sequence 106 from the input 100, the input analyzer 104 sends the audio sequence 106 (or the selected portion of the audio sequence 106) to an audio analyzer 110, as shown at numeral 3. In one or more embodiments, the input analyzer 104 stores the audio sequence 106 of the audio sequence in a memory or storage (e.g., input audio database 108) for later access by the audio analyzer 110.

In one or more embodiments, the audio analyzer 110 processes the audio sequence 106 using an audio model 111 to generate an audio embedding 112, as shown at numeral 4. In one or more embodiments, the audio model 111 is a convolutional neural network (e.g., an Inception network) trained to classify audio to generate the audio embedding 112. In one or more embodiments, a neural network is a deep learning architecture that extracts learned representations of audio. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In one or more embodiments, the audio analyzer 110 generates a single song-level audio embedding for the audio sequence 106. When the input 100 includes a selection of a portion of the audio sequence 106, the audio model 111 generates an audio embedding 112 for the selected portion of the audio sequence. In one or more embodiments, the audio model 111 can generate section-level audio embeddings of fixed-time resolutions or varying time resolutions and can generate the single song-level audio embedding by combining the section-level audio embeddings.

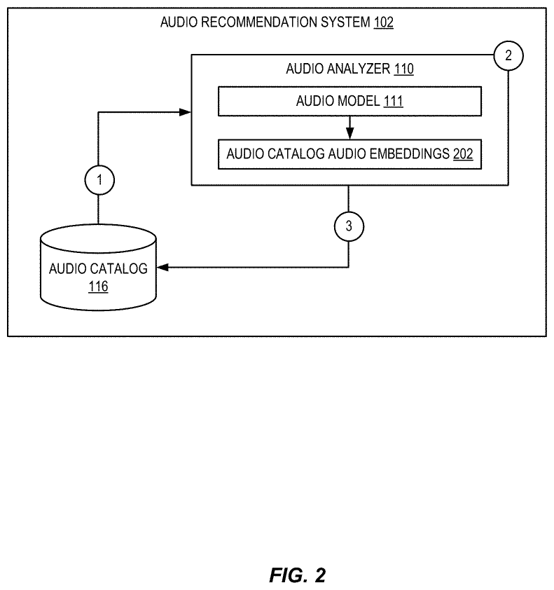

In one or more embodiments, the audio analyzer 110 sends the generated audio embedding 112 for the input audio sequence to an audio embeddings comparator 114, as shown at numeral 5. In one or more embodiments, the audio embeddings comparator 114 receives or retrieves search indices for catalog audio sequences in audio catalog 116, as shown at numeral 6. In one or more embodiments, each search index for a catalog audio sequence can include one or more catalog audio embeddings for the corresponding catalog audio sequence, where each audio embedding is a representation of the catalog audio sequence at different time resolutions. Additional details regarding the catalog audio embeddings generated at different time resolutions are described with respect to FIG. 2.

In one or more embodiments, the audio embeddings comparator 114 compares the audio embedding 112 with the catalog audio embeddings to generated ranked audio sequences 118, as shown at numeral 7. In one or more embodiments, the audio embeddings comparator 114 performs a two-stage approximate nearest neighbor search, to find catalog audio sequences that are both similar at a song-level and at a section-level within the song.

In one or more embodiments, for a nearest neighbor search without product quantization, the audio embeddings comparator 114 uses two main data structures per time resolution: 1) a large, flattened matrix of all audio embeddings for all catalog audio sequences for a given resolution concatenated together (e.g., one column of the matrix correspond to one embedding); and 2) a hash map structure where the keys are the column indices of the audio embedding in the flattened embedding matrix and the values stored are a catalog audio sequence identifier, a start time, and an end time (e.g., identifier, start time within catalog audio sequence, end time within catalog audio sequence) within the catalog audio sequence associated with the audio embedding. Then, given audio embedding 112 generated from input 100 (averaged across time for a specified length), the audio embeddings comparator 114 computes the similarity between the audio embedding 112 and each catalog audio embedding using a metric or score function (e.g., Euclidean distance, cosine distance, etc.). For example, the audio embeddings comparator 114 computes the squared Euclidean distance (proportional to cosine distance with L2 normalized embeddings) between the audio embedding 112 and the catalog audio embeddings, sorts the distances from smallest to largest, and returns ranked audio sequences 118 listing the most similar results (e.g., the comparisons with the smallest distances).

In one or more embodiments, to search across multiple time resolutions, the audio embeddings comparator 114 performs a multi-pass nearest neighbor search using two or more search indices that correspond to different time resolutions. For example, the audio embeddings comparator 114 first searches across a whole-song search index storing single song-level embedding for each audio sequence. The audio embeddings comparator 114 determines the top N most similar sounding catalog audio sequences and culls any catalog audio sequences that are too far away from the input audio sequence 106. Alternatively, instead of returning a fixed number of top results, the audio embeddings comparator 114 can also return all top results that have a distance below a specified threshold.

For example, the audio embeddings comparator 114 identifies the top 5,000 most similar catalog audio sequences out of 50,000 catalog audio sequences or returns the top results that all have a distance of 0.5 or less from the audio embedding 112 (e.g., since the audio embeddings are normalized, similarity=1−distance). Then, for the top N most similar catalog audio sequences, the audio embeddings comparator 114 searches across a shorter duration search index (e.g., an index corresponding to 10-second segments), computes a nearest neighbor search using only the 10-second segment embeddings for the top N catalog audio sequences, re-sorts the results, and provides a re-ranked search results (e.g., ranked audio sequences 118) that indicate not only the top most similar catalog audio sequences, but also the time region (segment) within the catalog audio sequences that are most similar to the input audio sequence 106.

In one or more embodiments, the audio recommendation system 102 provides an output 120, including the ranked audio sequences 118, as shown at numeral 8. In one or more embodiments, after the process described above in numerals 1-7 the output 120 is sent to the user or computing device that initiated the section-based, within-song music similarity search process with the audio recommendation system 102, to another computing device associated with the user or another user, or to another system or application. For example, after the process described above in numerals 1-7, the ranked audio sequences 118 can be displayed in a user interface of a computing device.

FIG. 2 illustrates a diagram of a process of processing an audio catalog using a section-based analysis in accordance with one or more embodiments. As shown in FIG. 2, in one or more embodiments, an audio analyzer 110 of an audio recommendation system 102 receives catalog audio sequences from an audio catalog database 116 as part of a request to perform a section-based, within-song music analysis, as shown at numeral 1.

In one or more embodiments, the audio analyzer 110 processes the catalog audio sequences using an audio model 111 to generate audio catalog audio embeddings 202, as shown at numeral 2. In one or more embodiments, the audio model 111 is a convolutional neural network (e.g., an Inception network) trained to classify audio. The audio model 111 can generate a plurality of audio catalog audio embeddings 202 for each catalog audio sequence, where each audio catalog audio embeddings 202 represents the catalog audio sequence at a different time resolution. In one example, the audio model 111 computes short length audio embeddings (e.g., three-second long audio embeddings).

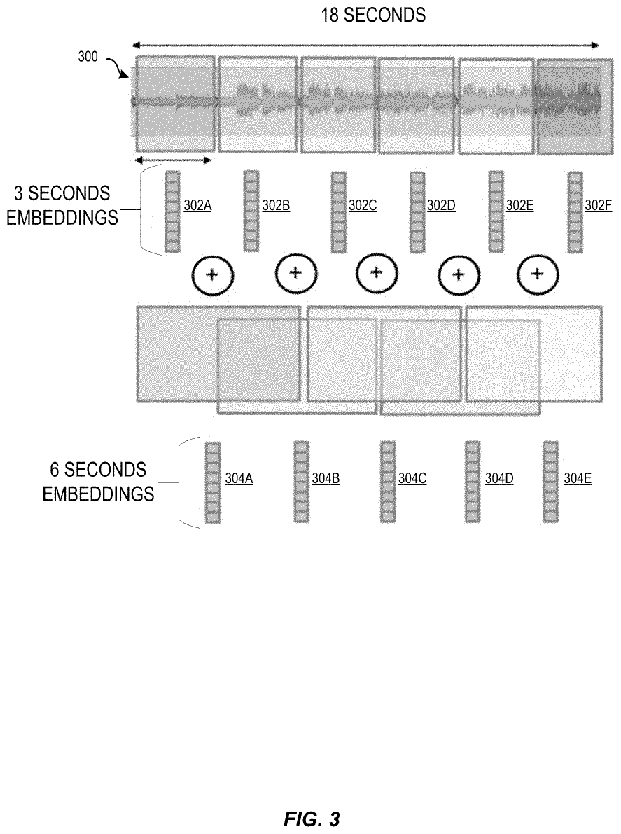

FIG. 3 illustrates an example result of processing an audio sequence using fixed time segments in accordance with one or more embodiments. As illustrated in FIG. 3, a 18-second portion of a catalog audio sequence 300 can be segmented into a series of three-second long segments, where three-second long audio embedding 302A is associated with time 0 seconds to 3 seconds, three-second long audio embedding 302B is associated with time 3 seconds to 6 seconds, three-second long audio embedding 302C is associated with time 6 seconds to 9 seconds, three-second long audio embedding 302D is associated with time 9 seconds to 12 seconds, three-second long audio embedding 302E is associated with time 12 seconds to 15 seconds, and three-second long audio embedding 302F is associated with time 15 seconds to 18 seconds, until all segments the catalog audio sequence is processed. Given a catalog audio sequence with a duration of three minutes, this process would result in approximately 60 audio embeddings for the catalog audio sequence. Given an audio catalog with 36,000 catalog audio sequences, this can result in approximately 2.16 million audio embeddings. In one or more embodiments, the 18-second portion of the catalog audio sequence 300 can be segmented into a series of segments of a different length (e.g., four seconds, five seconds, etc.).

In one or more embodiments, the audio embeddings can also overlap. For example, a first three-second long audio embedding can be associated with time 0 seconds to 3 seconds, a second three-second long audio embedding can be associated with time 1.5 seconds to 4.5 seconds, a third three-second long audio embedding can be associated with time 3 seconds to 6 seconds etc., until the catalog audio sequence is processed.

After generating the short length audio embeddings, the audio model 111 combines neighboring audio embeddings to generate audio embeddings corresponding to larger time resolutions. Continuing the example of FIG. 3, the audio model 111 generates six-second long audio embeddings 304A-304E from three-second long audio embeddings 302A-302F. Combining the neighboring audio embeddings can include averaging the audio embeddings or concatenating the audio embeddings. In one or more embodiments, combining the neighboring audio embeddings is performed by a model trained to take multiple audio embeddings as an input and output a single audio embedding. For example, audio embeddings 302A and 302B are averaged to generate six-second long audio embedding 304A, audio embeddings 302B and 302C are averaged to generate six-second long audio embedding 304B, audio embeddings 302C and 302D are averaged to generate six-second long audio embedding 304C, audio embeddings 302D and 302E are averaged to generate six-second long audio embedding 304D, and audio embeddings 302E and 302F are averaged to generate six-second long audio embedding 304E. The six-second long audio embeddings 304A-304E can be similarly averaged together to generate 12-second long audio embeddings, and so on until a song-level audio embedding can be generated.

In one or more embodiments, the audio model 111 that produces the audio catalog audio embeddings 202 is a trained neural network model. For example, a large convolutional neural network (e.g., Inception network) is trained to take as input a short 3-second audio sequence and predict one or more text-based music tags (e.g., genre tags), using a large collection of labeled music audio data. This approach is then extended using a multi-task learning setup to simultaneously predict genre, mood, instrument, and tempo tags. For training, binary cross-entropy loss is minimized for a multi-label problem setup. Once trained, the last fully connected layer of the network is detached, resulting in the convolutional model outputting an L2 normalized embedding (e.g., a 256-dimensional feature vector with L2 norm of one), which is used to compute music similarity. During training, equal balanced sampling is used on both the task and labels.

Returning to FIG. 2, once the audio embeddings at the various time resolutions have been generated, the audio embeddings are stored in the audio catalog 116, as shown at numeral 3. In one or more embodiments, the audio embeddings at the various time resolutions can be stored in separate search index data structures for each time resolution, or a single search index data structure for each catalog audio sequence.

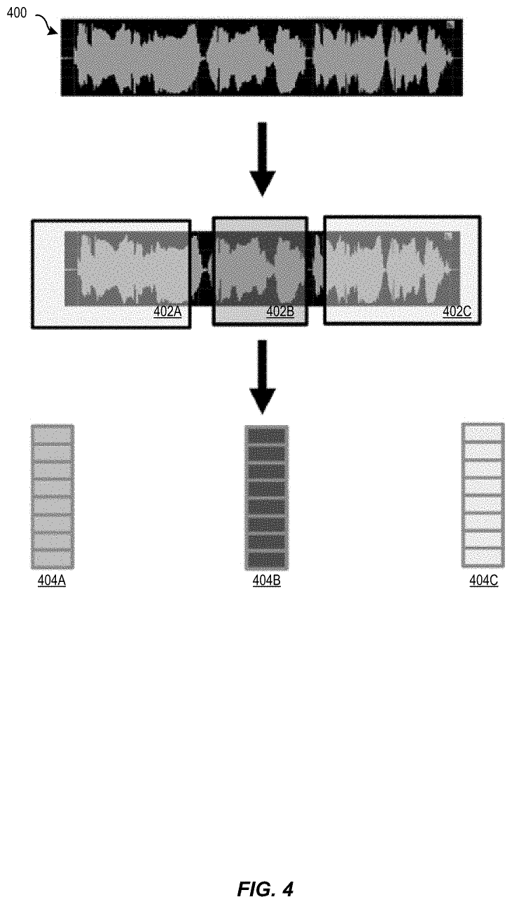

FIG. 4 illustrates an example result of processing an audio sequence using content-based variable time segments in accordance with one or more embodiments. In one or more embodiments, the audio analyzer 110 automatically divides audio sequences into musically motivated sections (e.g., intro, verse, chorus, etc.). To accomplish this, the audio analyzer 110 uses an automatic audio sectioning algorithm to segment each catalog audio sequence into self-consistent, musically motivated sections. Then, the audio analyzer 110 uses the start and stop regions (e.g., timecodes) for each automatically identified section to build a section-based search index using the method as discussed above with respect to FIG. 2. However, instead of using segments of a fixed size, such as 3 or 6 seconds, each catalog audio sequence is indexed using musically meaningful sections of varying duration. For example, a catalog audio sequence can be segmented into a 5 second intro, a 20 second verse, a 15 second chorus, another 20 second verse, and a 30 second chorus.

In one or more embodiments, the audio analyzer 110 builds the search indices for the catalog audio sequences in catalog audio 116 by using an audio model 111 to first compute short length audio embeddings (e.g., three-second long audio embeddings), as described with respect to FIG. 3. The audio analyzer 110 then averages the audio embeddings corresponding to each automatically identified section of a candidate audio sequence. The audio analyzer 110 then uses the section-based embeddings to composite the search index data structures as described previously, except that the start time and stop time associated with each audio embedding are not computed on a fixed grid and thus the audio embedding can have variable lengths.

As illustrated in FIG. 4, a catalog audio sequence 400 averages short length audio embeddings within each musically motivated section (e.g., sections 402A-402C) to generate audio embeddings 404A-404C. The candidate audio sequence id, start time of the section, and end time of the section are associated with each of audio embeddings 404A-404C and are used to build a search index with variable length sections per candidate audio sequence.

Generating audio embeddings of variable lengths based on determining the musically motivated sections has two main advantages. First, it can reduce the size of the search indices, since each song is divided into musically motivated sections, rather than based on time. For example, if a candidate audio sequence has a 15 second chorus segment, which is highly similar to itself (e.g., the candidate audio sequence mostly sounds the same during these 15 seconds), there is no need for the audio analyzer 110 to index shorter sections since they would be redundant. This allows for a reduction in the size of the search index while still being able to index varying musical content within each candidate audio sequence. Second, this allows the audio recommendation system to point the user directly to the most closely matching music section within a candidate audio sequence so the user can start listening from the beginning of that section, which may be more pleasing to the user than starting to listen at an arbitrary point of a song.

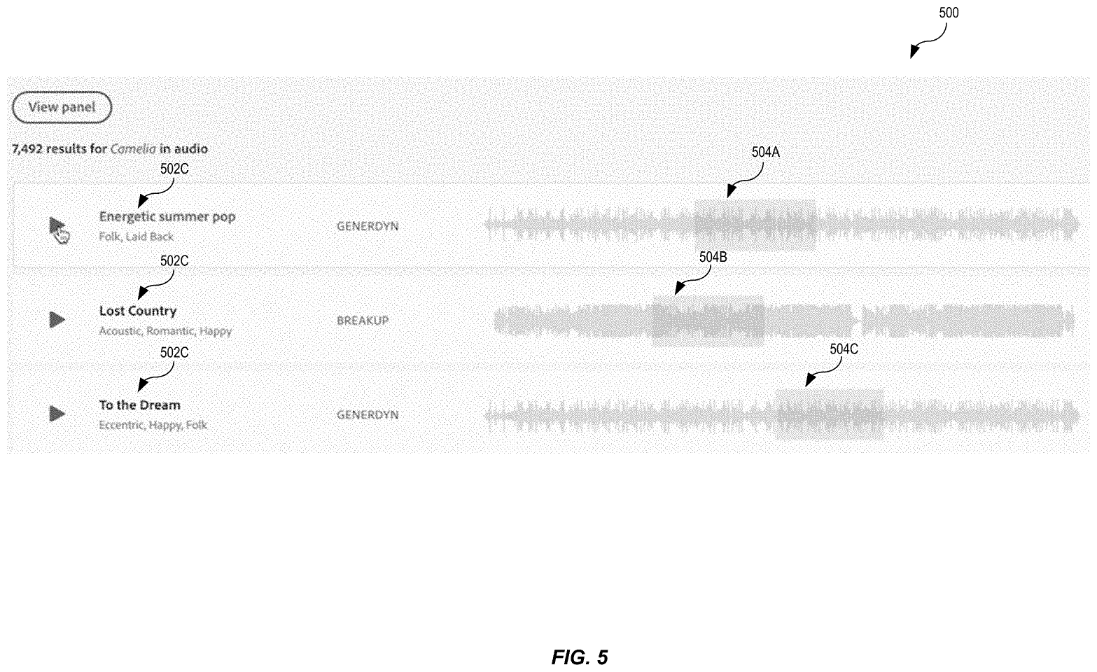

FIG. 5 illustrates an example search results interface 500 in accordance with one or more embodiments. The search results interface 500 includes one or more search results of candidate audio sequences that have segments that are similar to the input audio sequence. As illustrated, candidate audio sequences 502A-C include matching audio sections 504A-C, respectively, that match an input audio sequence or a selected portion of an input audio sequence. In one or more embodiments, a playhead for each of the candidate audio sequences 502A-C can be set to play at the start of a corresponding matching audio sections.

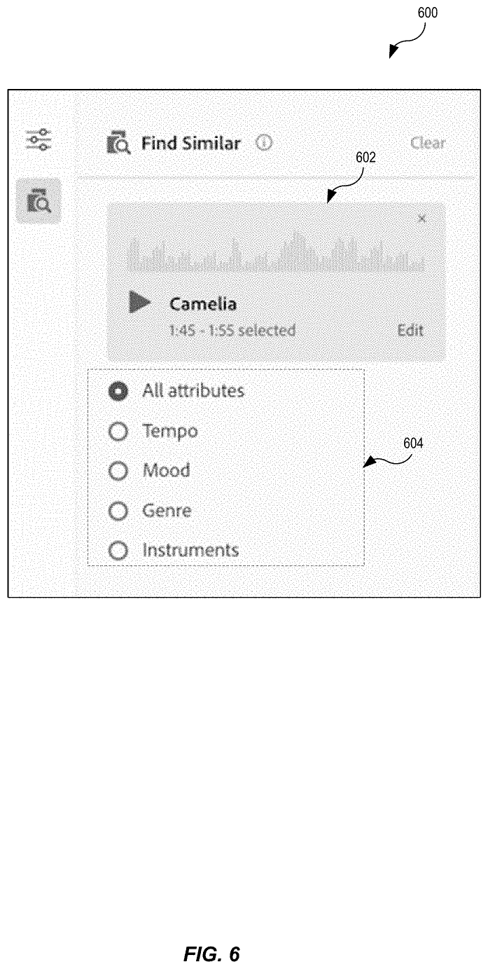

After generating the set of candidate audio sequences from the pre-processed audio catalog, the audio recommendation system can provide the user with an interface with options to apply a musical attributes filter to the set of candidate audio sequences. FIG. 6 illustrates an example musical attributes filtering interface 600 in accordance with one or more embodiments. The musical attributes filtering interface 600 provides input audio sequence data 602 that includes information on an input audio sequence, including a title of the input audio sequence and a user-selected portion of the input audio sequence. In the example illustrated in FIG. 6, the user has selected an input audio sequence titled, “Camelia,” and has selected timecodes 1:45 and 1:55 as the portion of the input audio sequence. In response, the audio recommendation system will identify candidate audio sequences with sections that include sections that match or are musically similar to the selected portion. The musical attributes filtering interface also includes filtering options 604 that can be selected to filter the set of candidate audio sequences that match the input audio sequence based on selected musical attributes, such as tempo, mood, genre, instruments, or a plurality of musical qualities. In one or more other embodiments, the filtering options 604 can include additional, fewer, and/or different options than those depicted in FIG. 6. As an example, selection of the “mood” similarity option in the filtering options 604 results in the audio recommendation system filtering the set of candidate audio sequences to include only catalog audio sequences having sections matching the predicted or identified “mood” of the input audio sequence.

By performing a multi-pass nearest neighbor search using multiple time resolutions, the audio recommendation system 102 realizes a significant computation efficiency. For example, if the audio recommendation system 102 were to naively search across a fixed grid of 3-second length embeddings for all 35,972 audio sequences of an audio catalog, the audio recommendation system 102 would end up computing over 1,751,682 nearest neighbor distance computations (with or without PQ speed ups). In contrast, using the multi-pass search, the audio recommendation system 102 first searches across a song-level index requiring only 35,972 nearest neighbor computations, then searches within audio sequences of the top 1,000 closest matching audio sequences. This results in an additional 48,000 distance computations for a 6-second duration within song index, or only 7,800 computations for an automatically sectioned within-song index (e.g., where each song has an average of only 7.8 sections per song). As a result, the audio recommendation system 102 described herein can perform two orders of magnitude fewer distance computations and simultaneously search across all relevant time resolutions (instead of only 6 second duration regions).

In one or more other embodiments, the audio analyzer 110 automatically divides an audio sequence into sections, or segments, by analyzing each beat of the audio sequence to determine the features of the beat and clustering beats that have similar features. In such embodiments, the audio recommendation system 102 can use a beat detection algorithm to detect each beat of the audio sequence. Once the beats data is determined, the audio analyzer 110 can process the beats data of the audio sequence using the audio model 111 trained to classify audio to generate the audio features. In one or more embodiments, the audio model 111 extracts features (e.g., signal processing transformations of the audio sequence) from the audio sequence that capture information of different musical qualities from the audio sequence using the beats data. For example, if the beats data for an audio sequence indicates that there are 500 beats across the audio sequence, the audio model 111 extracts features for each of the 500 beats. Each feature can be configured to capture different musical qualities from audio (e.g., harmony, timbre, etc.). The number of features extracted can vary from dozens to hundreds, depending on the configuration.

In one or more embodiments, a recurrence matrix captures the similarity between feature frames of an audio sequence to expose the song structure. It is a binary, squared, symmetrical matrix, R, such that Rᵢⱼ=1 if frames i and j are similar for a specific metric, e.g., cosine distance, and Rᵢⱼ=0 otherwise. The recurrence matrix, R, can be obtained by combining, or fusing, two recurrence matrices obtained from audio features: (1) R^{loc}, computed using deep embeddings learned via Few-Shot Learning (FSL), or MFCC features computed via DSP, to identify local similarity between consecutive beats of the audio sequence; and (2) R^{rep}, computed using Constant-Q transform (CQT) features to capture repetition across the entire audio sequence that are combined with DEEPSIM embeddings learned via a music auto-tagging model designed to capture music similarity across genre, mood, tempo, and era. R^{loc} can be used to detect sudden sharp changes in timbre, while R^{rep} can be used to capture long-term harmonic repetition. The matrices can be combined via a weighted sum controlled by a hyper-parameter μ∈[0, 1], which can be set manually or automatically. The result can be expressed as the following:

R=μR^{rep}+(1−μ)R^{loc}

The recurrence matrix, R, can be an unweighted, undirected graph, where each frame is a vertex and 1's in the recurrence matrix represent edges.

FSL is an area of machine learning that trains models that, once trained, are able to robustly recognize a new class given a handful of examples of the new class at inference time. In one or more embodiments, Prototypical Networks are used to embed audio such that perceptually similar sounds are also close in the embedding space. As such, these embeddings, which are computed from a time window (e.g., 0.5 seconds), can be viewed as a general-purpose, short-term, timbre similarity feature. By capturing local, short-term timbre similarity, sharp transitions can be identified as potential boundary locations. In some embodiments, when it is not possible to compute the FSL features, digital signal processing (DSP) can be used to compute mel-frequency cepstral coefficients (MFCC) features.

CQT features can be computed from an audio signal via the Constant-Q Transform. In one or more embodiments, Harmonic-Percussive Source Separation (HPSS) is applied to enhance the harmonic components of the audio signal. The CQT features are combined with deep audio embeddings that can capture other complementary music qualities that may be indicative of repetition, such as instrumentation, tempo, and mode. In one or more embodiments, using a disentangled multi-task classification learning yields embeddings having the best music retrieval results. In such embodiments, disentangled refers to the embedding space being divided into subspaces that capture different dimensions of music similarity. The full embedding of size 256 is divided into four disjoint subspaces, each of size 64, where each subspace captures similarity along one musical dimension: genre, mood, tempo, and era. The deep audio embeddings, which are obtained from a 3-second context window and trained on a music tagging dataset, can capture musical qualities that can be complementary to those captured by CQT. For example, genre is often a reasonable proxy for instrumentation; mood can be a proxy for tonality and dynamics; tempo is an important low-level quality in itself; and era, in addition to being related to genre, can be indicative of mixing and mastering effects. Combined, the full embedding, referred to as DEEPSIM, may surface repetitions along dimensions that are not captured by the CQT alone.

In one or more embodiments, the matrices are combined via a weighted sum controlled by hyper-parameters μ∈[0, 1] and γ∈[0, 1], which can be set manually or automatically, and can be expressed using the following equation:

R=μ(γR^{DEEPSIM}+(1−γ)R^{CQT})+(1−μ)R^{FSL}

where μ controls the relative importance of local versus repetition similarity, while γ controls the relative importance of CQT versus DEEPSIM features for repetition similarity. The three matrices are normalized prior to being combined to ensure their values are in the same [0, 1] range. In one or more embodiments, the initial parameterizations are set to μ=0.5, y=0.5, which gives equal weight to local similarity obtained via FSL features and repetition similarity given by the simple average of the R^{CQT} and R^{DEEPSIM} matrices.

After generating the audio features for the audio sequence, the audio recommendation system 102 can be configured to generate an audio segmentation representation of the audio sequence using the audio features. In one or more embodiments, spectral clustering is applied to the recurrence matrix, resulting in a per-beat cluster assignment. Segments are derived by grouping frames (e.g., beats) of the audio sequence by their cluster assignment. For example, each frame of the audio sequence is placed into one of a plurality of clusters based on its extracted features, where frames that are in the same cluster have similar musical qualities. Each of the frames can then be assigned a cluster identifier corresponding to its assigned cluster, and the frames can then be arranged in their original order (e.g., based on their corresponding timecodes). Different segments of the audio sequence can then be identified based on the cluster identifiers assigned to each frame. For example, the first 30 frames of the audio sequence may be assigned the same first cluster identifier indicating that they are all part of a first segment, the next 20 frames may be assigned the same second cluster identifier indicating that they are all part of a second segment, and so on. Non-consecutive segments that include frames assigned with the same cluster identifier represent a repetition within the audio sequence. For example, if the next 30 frames representing a third segment are assigned the same cluster identifier as the first segment, the first and third segments can be considered musically similar (e.g., repetitions having similar musical qualities).

In one or more embodiments, the number of clusters can be user-defined based on an input or a selection of a segment value, which indicates a number of unique clusters to divide the audio sequence into. For example, if the segment value is three, the beats of the audio sequence will be assigned to one of three unique clusters (which may repeat throughout the audio sequence), based on having similar features. Larger values for the segment value results in more unique clusters, increasing the granularity of each segment. In one or more embodiments, regardless of the segment value, the audio recommendation system 102 can be configured to generate a multi-level audio segmentation, where each level, starting from a first level, includes an increasingly greater number of clusters. For example, the audio recommendation system 102 may generate 12 levels of audio segmentation for an input audio sequence, where the frames of the audio sequence are in a single cluster at a first level, split into two clusters at a second level, and so on. In some embodiments, while 12 levels of audio segmentation are generated, the output provided is a single level (e.g., the level based on the user-defined segment value).

In some embodiments, a multi-level segment fusioning algorithm is used to reduce or eliminate short segments (e.g., segments shorter than a threshold length). Using the multi-level segment fusioning algorithm, short segments in the audio segmentation are fused, or merged, with neighboring segments based on the location of the short segments and/or based on analyzing lower levels of the multi-level segmentation representation of the audio sequence.

In one or more embodiments, this audio segmentation process can be performed on the audio sequences in audio catalog 116 and stored for subsequent searching in response to receiving an input audio sequence (e.g., audio sequence 106). In such embodiments, the section-based music similarity searching process described herein can be performed on the input audio sequence based on comparing the features associated with segments of the input audio sequence and the catalog audio sequences.

While embodiments described herein describe similarity searching of musical audio sequences, the embodiments can also be used to perform similarity searching of other time-varying media, including, but not limited to, non-musical audio and video. In these embodiments, searching video by segmenting video sequences can provide similar computational benefits as searching audio by segmenting audio sequences. For example, an automatic video sectioning algorithm can be applied to a video sequence to detect different scenes (e.g., outdoor vs. indoor, static vs. motion) within the video sequence. A search index can then be built based on the different detected scenes. For example, to build a content-based video search system that can perform a similarity search across nature scenes, a recommendation system could segment the video sequence, compute a single numerical description or video embedding of each video segment, and search only over video sequences with segments that have a target scene (e.g., forest, ocean, etc.). In one or more embodiments, video sequences can be segmented in other ways. For example, video sequences can be segmented using semantic labels or other automatic content detection methods.

In one or more embodiments, the audio recommendation can also be applied to non-musical audio. For example, the audio sequences can be segmented using different algorithm. Alternative automatic segmentation algorithms can include sound event detection algorithms for environmental audio (via automatic audio tagging) or speech audio (via a speaker id model).

In one or more embodiments, the audio recommendation system can also provide a recommendation of a specific user-defined length of the time. For example, a user may provide an input audio sequence and request a similar audio segment of a specific length (e.g., 10 seconds, 30 seconds, etc.). In such situations, instead of searching audio embeddings across all time segments and/or time resolutions, the audio recommendation system can perform a pre-computation step to identify self-similar segments, cull out any unnecessary content, and then perform search across only the pre-filtered segments.

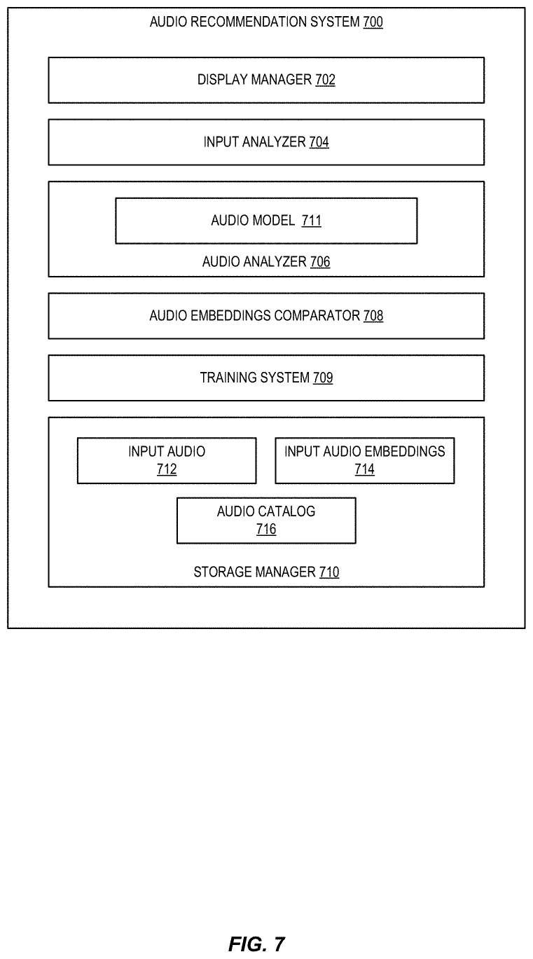

FIG. 7 illustrates a schematic diagram of an audio recommendation system (e.g., “audio recommendation system” described above) in accordance with one or more embodiments. As shown, the audio recommendation system 700 may include, but is not limited to, a display manager 702, an input analyzer 704, an audio analyzer 706, an audio embeddings comparator 708, a training system 709, and a storage manager 710. As shown, the audio analyzer 706 includes an audio model 711. As shown, the storage manager 710 includes input audio 712, input audio embeddings 714, and audio catalog 716.

As illustrated in FIG. 7, the audio recommendation system 700 includes a display manager 702. In one or more embodiments, the display manager 702 identifies, provides, manages, and/or controls a user interface provided on a touch screen or other device. Examples of displays include interactive whiteboards, graphical user interfaces (or simply “user interfaces”) that allow a user to view and interact with content items, or other items capable of display on a touch screen. For example, the display manager 702 may identify, display, update, or otherwise provide various user interfaces that include one or more display elements in various layouts. In one or more embodiments, the display manager 702 can identify a display provided on a touch screen or other types of displays (e.g., including monitors, projectors, headsets, etc.) that may be interacted with using a variety of input devices. For example, a display may include a graphical user interface including one or more display elements capable of being interacted with via one or more touch gestures or other types of user inputs (e.g., using a stylus, a mouse, or other input devices). Display elements include, but are not limited to buttons, text boxes, menus, thumbnails, scroll bars, hyperlinks, etc.

As further illustrated in FIG. 7, the audio recommendation system 700 also includes an input analyzer 704. The input analyzer 704 analyzes an input received by the audio recommendation system 700 to identify an input audio sequence, and if provided in the input, a selection of a portion of the input audio sequence. In one or more embodiments, the input analyzer 704 extracts the input audio sequence from the input.

As further illustrated in FIG. 7, the audio recommendation system 700 also includes an audio analyzer 706 configured to generate audio embeddings for input audio sequences and catalog audio sequences. The audio analyzer 706 can be implemented as, or include, one or more machine learning models, such as a neural network or a deep learning model. For example, the audio analyzer 706 can include an audio model 711 configured to convert an audio sequence into a semantically meaningful 256-dimensional audio embedding. In one or more embodiments, the audio analyzer 706 is a large convolutional neural network (e.g., an Inception network) configured to first generate audio embeddings from an audio sequence at a shorter-length time resolution (e.g., three seconds long). These audio embeddings may overlap or may be adjacent to each other. After generating a set of audio embeddings at the shorter-length time resolution, the audio model 711 can combine neighboring audio embeddings to generate audio embeddings of a longer fixed-length time resolution (e.g., six seconds long, twelve seconds long, etc.). The audio model 711 can continue this process until it generates a song-level audio embedding from the audio embeddings at the shorter-length time resolution.

In one or more embodiments, after generating the audio embeddings at the shorter-length time resolution, neighboring audio embeddings that are of the same self-consistent, musically motivated section (e.g., intro, chorus, verse, etc.), as determined by an automatic audio sectioning algorithm, are combined, e.g., by averaging the audio embeddings of the same section. In such embodiments, because only audio embeddings of the same self-consistent, musically motivated section are combined, the resulting audio embeddings are variable in time resolution (e.g., 10 second time resolution for an intro, 20 second time resolution for a chorus, etc.).

As further illustrated in FIG. 7, the audio recommendation system 700 also includes an audio embeddings comparator 708 configured to compare an audio embedding for an input audio sequence with the catalog audio embeddings of catalog audio sequences to generate a list of audio sequences ranked by similarity to the input audio sequence. In one or more embodiments, the audio embeddings comparator 708 performs a two-stage approximate nearest neighbor search, to find catalog audio sequences that are both similar at a song-level and at a section-level within the song. The two-stage, or multi-pass, process includes comparing the audio embedding for the input audio sequence against song-level audio embeddings for the catalog audio sequences. After determining a set of candidate audio sequences representing a subset of the catalog audio sequences closest in similarity to the input audio sequence, the audio recommendation system uses segment or section-level audio embeddings for the set of candidate audio sequences to determine sections within the set of candidate audio sequences that most closely match the input audio sequence. The audio embeddings comparator 708 then re-ranks the set of candidate audio sequences is based on this determination of the sections within the set of candidate audio sequences that most closely match the input audio sequence.

As further illustrated in FIG. 7, the audio recommendation system 700 includes training system 709 which is configured to teach, guide, tune, and/or train one or more neural networks. In particular, the training system 709 trains a neural network, such as audio model 711, based on training data.

As further illustrated in FIG. 7, the storage manager 710 includes input audio 712, input audio embeddings 714, and audio catalog 716. In particular, the input audio 712 may include an input audio sequence received by the audio recommendation system 700. In one or more embodiments, the input analyzer 704 stores the input audio sequence or information associated with the input audio sequence in the input audio 712 instead of, or in addition to, sending the data to the audio analyzer 706. The input audio embeddings 714 may include the audio embeddings generated by the audio analyzer 706. The audio catalog 716 may include a plurality of catalog audio sequences and search index data structures storing the audio embeddings of different time resolutions for the catalog audio sequences.

Each of the components 702-710 of the audio recommendation system 700 and their corresponding elements (as shown in FIG. 7) may be in communication with one another using any suitable communication technologies. It will be recognized that although components 702-710 and their corresponding elements are shown to be separate in FIG. 7, any of components 702-710 and their corresponding elements may be combined into fewer components, such as into a single facility or module, divided into more components, or configured into different components as may serve a particular embodiment.

The components 702-710 and their corresponding elements can comprise software, hardware, or both. For example, the components 702-710 and their corresponding elements can comprise one or more instructions stored on a computer-readable storage medium and executable by processors of one or more computing devices. When executed by the one or more processors, the computer-executable instructions of the audio recommendation system 700 can cause a client device and/or a server device to perform the methods described herein. Alternatively, the components 702-710 and their corresponding elements can comprise hardware, such as a special purpose processing device to perform a certain function or group of functions. Additionally, the components 702-710 and their corresponding elements can comprise a combination of computer-executable instructions and hardware.

Furthermore, the components 702-710 of the audio recommendation system 700 may, for example, be implemented as one or more stand-alone applications, as one or more modules of an application, as one or more plug-ins, as one or more library functions or functions that may be called by other applications, and/or as a cloud-computing model. Thus, the components 702-710 of the audio recommendation system 700 may be implemented as a stand-alone application, such as a desktop or mobile application. Furthermore, the components 702-710 of the audio recommendation system 700 may be implemented as one or more web-based applications hosted on a remote server. Alternatively, or additionally, the components of the audio recommendation system 700 may be implemented in a suit of mobile device applications or “apps.” To illustrate, the components of the audio recommendation system 700 may be implemented in a document processing application or an image processing application, including but not limited to ADOBE® Premiere Pro, ADOBE® Premiere Rush, ADOBE® Audition CC, and ADOBE® Stock, ADOBE® Premiere Elements, etc., or a cloud-based suite of applications such as CREATIVE CLOUD®. “ADOBE®,” “ADOBE PREMIERE®,” and “CREATIVE CLOUD®” are either a registered trademark or trademark of Adobe Inc. in the United States and/or other countries.

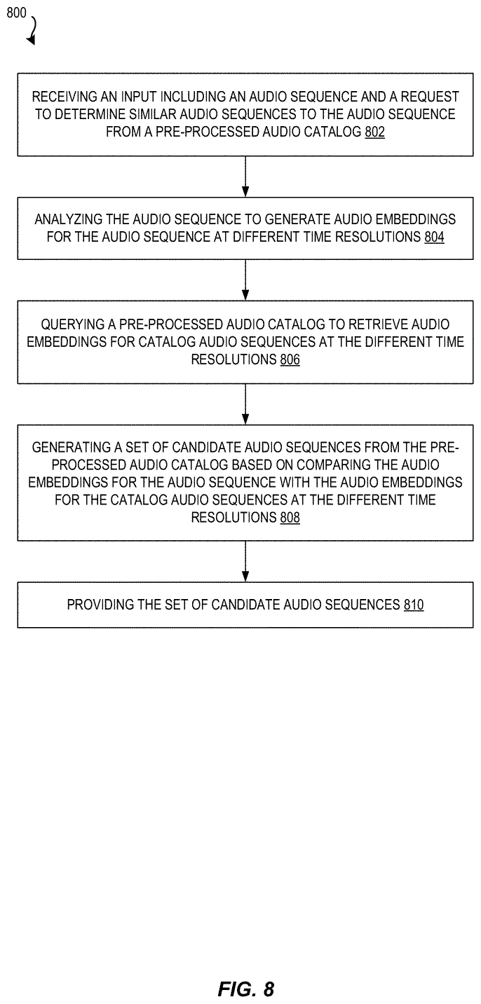

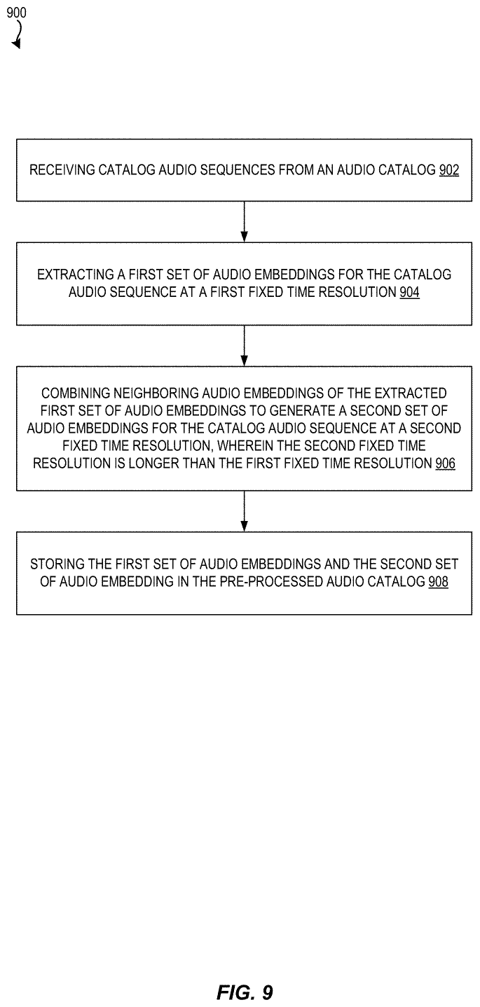

FIGS. 1-7, the corresponding text, and the examples, provide a number of different systems and devices that allow an audio recommendation system to perform section-based, within-song music similarity searching. In addition to the foregoing, embodiments can also be described in terms of flowcharts comprising acts and steps in a method for accomplishing a particular result. For example, FIGS. 8 and 9 illustrate flowcharts of exemplary methods in accordance with one or more embodiments. The methods described in relation to FIGS. 8 and 9 may be performed with less or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart of a series of acts in a method of performing a section-based, within-song music similarity search by an audio recommendation system in accordance with one or more embodiments. In one or more embodiments, the method 800 is performed in a digital medium environment that includes the audio recommendation system 700. The method 800 is intended to be illustrative of one or more methods in accordance with the present disclosure and is not intended to limit potential embodiments. Alternative embodiments can include additional, fewer, or different steps than those articulated in FIG. 8.

As shown in FIG. 8, the method 800 includes an act 802 of receiving an input including an audio sequence and a request to determine similar audio sequences to the audio sequence from a pre-processed audio catalog. In one or more embodiments, the input includes at least the audio sequence to be used for a music similarity search. In one or more embodiments, the audio recommendation system receives the input from a user (e.g., via a computing device). In one or more embodiments, the user may select the audio sequence in an application, or the user may submit the audio sequence to a web service or an application configured to receive inputs. The audio sequence can also be a portion selected from a longer audio sequence. For example, after providing the audio sequence to the application, the application can provide an interface to enable the user to select a portion of the longer audio sequence.

As shown in FIG. 8, the method 800 also includes an act 804 of analyzing the audio sequence to generate audio embeddings for the audio sequence at different time resolutions. In one or more embodiments, the audio recommendation system extracts a first set of audio embeddings for the audio sequence at a first resolution, and then combines the extracted first set of audio embeddings to generate a second set of audio embedding for the audio sequence at a second resolution, where the second resolution is longer than the first resolution. For example, neighboring audio embeddings can be averaged together to generate the second set of audio embedding at the second resolution. This process of combining neighboring audio embeddings can be repeated to generate additional sets of audio embeddings at larger resolutions, up to a set of audio embeddings at the song level.

As shown in FIG. 8, the method 800 also includes an act 806 of querying a pre-processed audio catalog to retrieve audio embeddings for catalog audio sequences at the different time resolutions. In one or more embodiments, the audio recommendation system can first retrieve or otherwise access search indices for each of a plurality of catalog audio sequences from the audio catalog. The search indices can include a first search index that includes single song-level audio embeddings for each catalog audio sequence, and a second search index that includes one or more section-level audio embeddings for each catalog audio sequence at different time resolutions. For example, the section-level audio embeddings for each catalog audio sequence can be the same time resolutions as the audio embeddings generated for the input audio sequence. In some embodiments, a single search index can be used to store the song-level and section-level audio embeddings. The section-level audio embeddings can include audio embeddings of fixed-length time resolutions and/or audio embeddings of varying-length time resolutions.

As shown in FIG. 8, the method 800 also includes an act 808 of generating a set of candidate audio sequences from the pre-processed audio catalog based on comparing the audio embeddings for the audio sequence with the audio embeddings for the catalog audio sequences at the different time resolutions. In one or more embodiments, the audio recommendation system generates a first set of candidate audio sequences based on comparing the audio embedding for the audio sequence with song-level audio embeddings from a first search index for audio sequences in the pre-processed audio catalog. The audio recommendation system can then generate a second set of candidate audio sequences based on comparing the audio embedding for the audio sequence with section-level audio embeddings from a second search index for the first set of candidate audio sequences, where the second set of candidate audio sequences is smaller than the first set of candidate audio sequences. The audio recommendation system then generates, the set of candidate audio sequences by ranking the second set of candidate audio sequences based on their similarity to the audio sequence, where their similarity is determined at the section level.

As shown in FIG. 8, the method 800 also includes an act 810 of providing the set of candidate audio sequences. In one or more embodiments, the audio recommendation system can display the set of candidate audio sequences in a user interface. For example, the set of candidate audio sequences can be presented on a user interface on the user computing device that submitted the request to perform the music similarity search. For each candidate audio sequence provided to the user, the audio recommendation can highlight at least a portion of the candidate audio sequence closest in similarity to the audio sequence and set a playhead at a starting timecode of the portion of the candidate audio sequence closest in similarity to the audio sequence. In one or more other embodiments, the set of candidate audio sequences can be transmitted to the user computing device as a file.

FIG. 9 illustrates a flowchart of a series of acts in a method of processing catalog audio sequences to generate section-level audio embeddings by an audio recommendation system in accordance with one or more embodiments. In one or more embodiments, the method 900 is performed in a digital medium environment that includes the audio recommendation system 700. The method 900 is intended to be illustrative of one or more methods in accordance with the present disclosure and is not intended to limit potential embodiments. Alternative embodiments can include additional, fewer, or different steps than those articulated in FIG. 9.

As shown in FIG. 9, the method 900 includes an act 902 of receiving catalog audio sequences from an audio catalog. In one or more embodiments, the audio recommendation system receives the catalog audio sequences from a user (e.g., via a computing device). In one or more embodiments, the user may select the catalog audio sequences in an application, or the user may submit the catalog audio sequences to a web service or an application configured to receive inputs.

As shown in FIG. 9, the method 900 includes an act 904 of extracting a first set of audio embeddings for each catalog audio sequence at a first fixed time resolution. In one or more embodiments, the first fixed time resolution is a short length time resolution (e.g., two second, three seconds, etc.). Each audio embedding of the first set of audio embeddings can represent a separate segment of the catalog audio sequence. For example, a first audio embedding can represent time 0-3 seconds of the catalog audio sequence, a second audio embedding can represent time 3-6 seconds of the catalog audio sequence, etc. In another embodiment, each audio embedding can overlap with a neighboring audio sequence. For example, a first audio embedding can represent time 0-3 seconds of the catalog audio sequence, a second audio embedding can represent time 1.5-4.5 seconds of the catalog audio sequence, etc.

As shown in FIG. 9, the method 900 includes an act 906 of combining neighboring audio embeddings of the extracted first set of audio embeddings to generate a second set of audio embeddings for the catalog audio sequence at a second fixed time resolution, wherein the second fixed time resolution is longer than the first fixed time resolution. In one or more embodiment, combining the neighboring audio embeddings includes averaging the neighboring embeddings at the first fixed time resolution to generate the second set of audio embeddings for the catalog audio sequence at the second fixed time resolution, wherein the second fixed time resolution is larger than the first fixed time resolution. For example, where the first set of audio embeddings have a time resolution of three seconds, the second set of audio embeddings generated from combining the first set of audio embeddings can have a time resolution of six seconds. In one or more embodiments, the set of audio embeddings can be further combined into larger time resolutions until a song-level audio embedding representing the entire audio sequence is generated.

In one or more other embodiments, where the catalog audio sequence has been segmented into self-consistent musical sections by an audio sectioning algorithm, the audio recommendation system can combine neighboring audio embeddings of the extracted first set of audio embeddings to generate a second set of audio embeddings for the catalog audio sequence of variable length resolutions based on the self-consistent musical sections. For example, neighboring audio embedding that have been determined to be a chorus section of the catalog audio sequence can be combined by averaging the audio embeddings associated with timecodes of the chorus section, neighboring audio embedding that have been determined to be an intro section of the catalog audio sequence can be combined by averaging the audio embeddings associated with timecodes of the intro section, and so on.

As shown in FIG. 9, the method 900 includes an act 908 of storing the first set of audio embeddings and the second set of audio embedding in the pre-processed audio catalog. The first set of audio embeddings and the second set of audio embeddings, and any other sets of audio embeddings generated at larger time resolutions, can then be stored in search indices. The audio embeddings can be associated with an audio sequence identifier and timecodes corresponding to locations within the audio sequence associated with the audio embeddings.

In one or more embodiments, after receiving the audio sequence to be used for the music similarity search, the audio recommendation system analyzes the audio sequence to automatically predict or identify characteristics of various musical attributes of the audio sequence (e.g., using a music tagging algorithm). Examples of musical attributes, or concepts, can include tempo, mood, genre, and instruments. In one or more embodiments, the music tagging algorithm includes a neural network trained to simultaneously predict mood, genre, tempo, and instrument tags. In one or more embodiments, the neural network is a multi-headed classification network. The neural network inputs a mel-spectrogram representation into an Inception-style convolutional neural network (CNN) that computes a fixed-size embedding for a given input audio sequence. In one or more embodiments, the neural network is the same network that is used to compute the audio embeddings used for the section-based similarity search. The embeddings generated by the music tagging algorithm are then processed through four independent dense layers to output the probability of one or more tags associated with separate musical concepts including genre, mood, tempo, and instruments. In one or more embodiments, the dense layers connected to the CNN embedding outputs are connected to sub-portions of the embeddings. For example, the dense layer associated with the genre tags is only connected to the first 64 elements of the CNN outputs, the dense layer associated with the mood tags is only connected to the 64th-128th elements of the CNN outputs, etc.

In one or more embodiments, the neural network is trained using binary cross-entropy loss using human-labeled (music, tag) pairs. For tempo tags, tempo is quantized into musically-motivated tempo regions (e.g., largo, allegro, presto). All but tempo range tags can have multiple labels associated with it (e.g., multiple genres can be active at once).

In such embodiments, when the audio recommendation system processes the catalog audio sequences to generate the section-level audio embeddings, the audio recommendation system can further predict or identify characteristics of various musical attributes of individual sections within each catalog audio sequence in the same manner as described above with respect to the input audio sequence. In one or more embodiments, the audio recommendation system can use ground truth tags (e.g., as determined by a human or by the process used to automatically predict or identify the musical attributes of the input audio sequence. The audio recommendation can assign tags to each section of candidate audio sequences based on the predicted/identified characteristics of the various musical attributes. In some embodiments, the audio recommendation system can compute the top tags per section of the catalog audio sequences and store this additional information in the audio catalog. In other embodiments, the audio recommendation system can compute a function/combination of the top tags of the catalog audio sequences. For example, the audio recommendation system can apply a threshold to the predicted or identified tag probabilities to ensure the tag probabilities are above a threshold value.

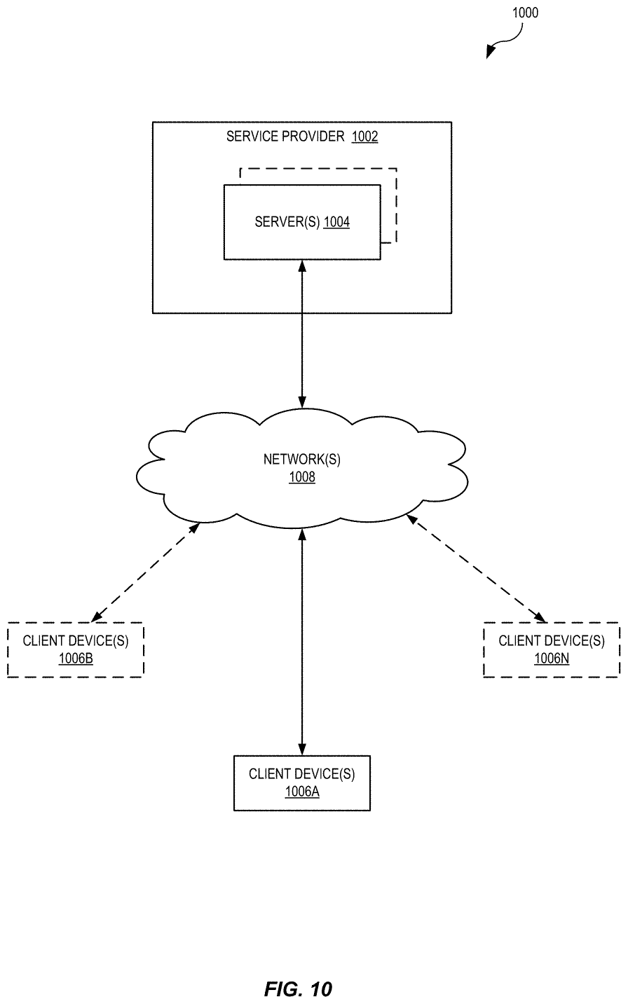

FIG. 10 illustrates a schematic diagram of an exemplary environment 1000 in which the audio recommendation system 700 can operate in accordance with one or more embodiments. In one or more embodiments, the environment 1000 includes a service provider 1002 which may include one or more servers 1004 connected to a plurality of client devices 1006A-1006N via one or more networks 1008. The client devices 1006A-1006N, the one or more networks 1008, the service provider 1002, and the one or more servers 1004 may communicate with each other or other components using any communication platforms and technologies suitable for transporting data and/or communication signals, including any known communication technologies, devices, media, and protocols supportive of remote data communications, examples of which will be described in more detail below with respect to FIG. 10.

Although FIG. 10 illustrates a particular arrangement of the client devices 1006A-1006N, the one or more networks 1008, the service provider 1002, and the one or more servers 1004, various additional arrangements are possible. For example, the client devices 1006A-1006N may directly communicate with the one or more servers 1004, bypassing the network 1008. Or alternatively, the client devices 1006A-1006N may directly communicate with each other. The service provider 1002 may be a public cloud service provider which owns and operates their own infrastructure in one or more data centers and provides this infrastructure to customers and end users on demand to host applications on the one or more servers 1004. The servers may include one or more hardware servers (e.g., hosts), each with its own computing resources (e.g., processors, memory, disk space, networking bandwidth, etc.) which may be securely divided between multiple customers, each of which may host their own applications on the one or more servers 1004. In some embodiments, the service provider may be a private cloud provider which maintains cloud infrastructure for a single organization. The one or more servers 1004 may similarly include one or more hardware servers, each with its own computing resources, which are divided among applications hosted by the one or more servers for use by members of the organization or their customers.

Similarly, although the environment 1000 of FIG. 10 is depicted as having various components, the environment 1000 may have additional or alternative components. For example, the environment 1000 can be implemented on a single computing device with the audio recommendation system 700. In particular, the audio recommendation system 700 may be implemented in whole or in part on the client device 1006A. Alternatively, in some embodiments, the environment 1000 is implemented in a distributed architecture across multiple computing devices.

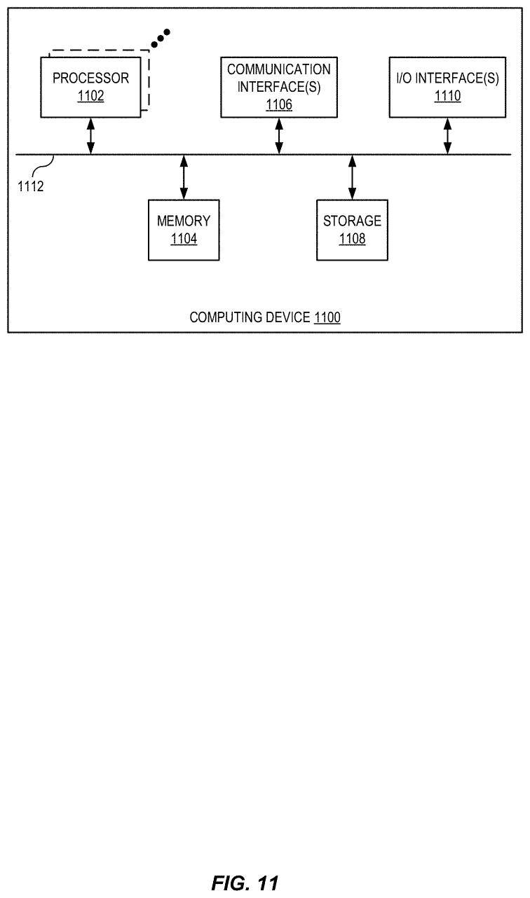

As illustrated in FIG. 10, the environment 1000 may include client devices 1006A-1006N. The client devices 1006A-1006N may comprise any computing device. For example, client devices 1006A-1006N may comprise one or more personal computers, laptop computers, mobile devices, mobile phones, tablets, special purpose computers, TVs, or other computing devices, including computing devices described below with regard to FIG. 11. Although three client devices are shown in FIG. 10, it will be appreciated that client devices 1006A-1006N may comprise any number of client devices (greater or smaller than shown).

Moreover, as illustrated in FIG. 10, the client devices 1006A-1006N and the one or more servers 1004 may communicate via one or more networks 1008. The one or more networks 1008 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 1008 may be any suitable network over which the client devices 1006A-1006N may access the service provider 1002 and server 1004, or vice versa. The one or more networks 1008 will be discussed in more detail below with regard to FIG. 11.

In addition, the environment 1000 may also include one or more servers 1004. The one or more servers 1004 may generate, store, receive, and transmit any type of data, including input audio 712, input audio embeddings 714, and audio catalog 716, or other information. For example, a server 1004 may receive data from a client device, such as the client device 1006A, and send the data to another client device, such as the client device 1006B and/or 1006N. The server 1004 can also transmit electronic messages between one or more users of the environment 1000. In one example embodiment, the server 1004 is a data server. The server 1004 can also comprise a communication server or a web-hosting server. Additional details regarding the server 1004 will be discussed below with respect to FIG. 11.

As mentioned, in one or more embodiments, the one or more servers 1004 can include or implement at least a portion of the audio recommendation system 700. In particular, the audio recommendation system 700 can comprise an application running on the one or more servers 1004 or a portion of the audio recommendation system 700 can be downloaded from the one or more servers 1004. For example, the audio recommendation system 700 can include a web hosting application that allows the client devices 1006A-1006N to interact with content hosted at the one or more servers 1004. To illustrate, in one or more embodiments of the environment 1000, one or more client devices 1006A-1006N can access a webpage supported by the one or more servers 1004. In particular, the client device 1006A can run a web application (e.g., a web browser) to allow a user to access, view, and/or interact with a webpage or website hosted at the one or more servers 1004.

Upon the client device 1006A accessing a webpage or other web application hosted at the one or more servers 1004, in one or more embodiments, the one or more servers 1004 can provide a user of the client device 1006A with an interface to provide inputs, including an audio sequence. Upon receiving the audio sequence, the one or more servers 1004 can automatically perform the methods and processes described above to perform section-based, within-song music similarity searching.

As just described, the audio recommendation system 700 may be implemented in whole, or in part, by the individual elements 1002-1008 of the environment 1000. It will be appreciated that although certain components of the audio recommendation system 700 are described in the previous examples with regard to particular elements of the environment 1000, various alternative implementations are possible. For instance, in one or more embodiments, the audio recommendation system 700 is implemented on any of the client devices 1006A-1006N. Similarly, in one or more embodiments, the audio recommendation system 700 may be implemented on the one or more servers 1004. Moreover, different components and functions of the audio recommendation system 700 may be implemented separately among client devices 1006A-1006N, the one or more servers 1004, and the network 1008.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 that may be configured to perform one or more of the processes described above. One will appreciate that one or more computing devices such as the computing device 1100 may implement the audio recommendation system 700. As shown by FIG. 11, the computing device can comprise a processor 1102, memory 1104, one or more communication interfaces 1106, a storage device 1108, and one or more input or output (“I/O”) devices/interfaces 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1108 and decode and execute them. In various embodiments, the processor(s) 1102 may include one or more central processing units (CPUs), graphics processing units (GPUs), field programmable gate arrays (FPGAs), systems on chip (SoC), or other processor(s) or combinations of processors.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1104 may be internal or distributed memory.

The computing device 1100 can further include one or more communication interfaces 1106. A communication interface 1106 can include hardware, software, or both. The communication interface 1106 can provide one or more interfaces for communication (such as, for example, packet-based communication) between the computing device and one or more other computing devices 1100 or one or more networks. As an example, and not by way of limitation, communication interface 1106 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can comprise hardware, software, or both that couples components of computing device 1100 to each other.

The computing device 1100 includes a storage device 1108 includes storage for storing data or instructions. As an example, and not by way of limitation, storage device 1108 can comprise a non-transitory storage medium described above. The storage device 1108 may include a hard disk drive (HDD), flash memory, a Universal Serial Bus (USB) drive or a combination these or other storage devices. The computing device 1100 also includes one or more I/O devices/interfaces 1110, which are provided to allow a user to provide input to (such as user strokes), receive output from, and otherwise transfer data to and from the computing device 1100. These I/O devices/interfaces 1110 may include a mouse, keypad or a keyboard, a touch screen, camera, optical scanner, network interface, modem, other known I/O devices or a combination of such I/O devices/interfaces 1110. The touch screen may be activated with a stylus or a finger.

The I/O devices/interfaces 1110 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1110 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A computer-implemented method, comprising:
receiving an input including an audio sequence and a request to determine similar audio sequences to the audio sequence from a pre-processed audio catalog;
analyzing the audio sequence to generate audio embeddings for the audio sequence at different time resolutions;
querying a pre-processed audio catalog to retrieve audio embeddings for catalog audio sequences at the different time resolutions;
generating a set of candidate audio sequences from the pre-processed audio catalog based on comparing the audio embeddings for the audio sequence with the audio embeddings for the catalog audio sequences at the different time resolutions; and
providing the set of candidate audio sequences.

2. The computer-implemented method of claim 1, wherein analyzing the audio sequence to generate the audio embeddings for the audio sequence at the different time resolutions comprises:
extracting a first set of audio embeddings for the audio sequence at a first resolution; and
combining the extracted first set of audio embeddings to generate a second set of audio embedding for the audio sequence at a second resolution, the second resolution longer than the first resolution.

3. The computer-implemented method of claim 1, wherein generating the set of candidate audio sequences from the pre-processed audio catalog based on comparing the audio embeddings for the audio sequence with the audio embeddings for the catalog audio sequences at the different time resolutions comprises:
generating a first set of candidate audio sequences based on comparing the audio embeddings for the audio sequence with song-level audio embeddings from a first search index for audio sequences in the pre-processed audio catalog;
generating a second set of candidate audio sequences based on comparing the audio embeddings for the audio sequence with section-level audio embeddings from a second search index for the first set of candidate audio sequences; and
generating the set of candidate audio sequences by ranking the second set of candidate audio sequences based on their similarity to the audio sequence.

4. The computer-implemented method of claim 1, wherein providing the set of candidate audio sequences further comprises:
displaying the set of candidate audio sequences in a user interface; and
for each candidate audio sequence in the set of candidate audio sequences,
highlighting at least a portion of the candidate audio sequence closest in similarity to the audio sequence, and
setting a playhead at a starting timecode of the portion of the candidate audio sequence closest in similarity to the audio sequence.

5. The computer-implemented method of claim 1, further comprising:
generating the pre-processed audio catalog by:
receiving the catalog audio sequences from an audio catalog; and
for each catalog audio sequence of the catalog audio sequences from the audio catalog,
extracting a first set of audio embeddings for the catalog audio sequence at a first fixed time resolution,
combining neighboring audio embeddings of the extracted first set of audio embeddings to generate a second set of audio embeddings for the catalog audio sequence at a second fixed time resolution, wherein the second fixed time resolution is longer than the first fixed time resolution, and
storing the first set of audio embeddings and the second set of audio embeddings in the pre-processed audio catalog.

6. The computer-implemented method of claim 5, wherein combining the neighboring audio embeddings of the extracted first set of audio embeddings comprises:
averaging the neighboring audio embeddings at the first fixed time resolution to generate the second set of audio embeddings for the catalog audio sequence at the second fixed time resolution, wherein the second fixed time resolution is larger than the first fixed time resolution.

7. The computer-implemented method of claim 1, further comprising:
generating the pre-processed audio catalog by:
receiving the catalog audio sequences from an audio catalog; and
for each catalog audio sequence of the catalog audio sequences from the audio catalog,
applying an automatic audio sectioning algorithm to segment the catalog audio sequence into self-consistent musical sections,
extracting a first set of audio embeddings for the catalog audio sequence at a first fixed time resolution,
combining neighboring audio embeddings of the extracted first set of audio embeddings to generate a second set of audio embeddings for the catalog audio sequence of variable length resolutions based on the self-consistent musical sections, and
storing the first set of audio embeddings and the second set of audio embeddings in the pre-processed audio catalog.

8. The computer-implemented method of claim 1, wherein analyzing the audio sequence to generate the audio embeddings for the audio sequence comprise:
determining characteristics of musical attributes of the audio sequence, the musical attributes including mood, genre, tempo, and instruments.

9. The computer-implemented method of claim 8, wherein generating the set of candidate audio sequences from the pre-processed audio catalog based on the audio embeddings for the audio sequence comprises:
receiving a selection of a musical attribute for filtering the set of candidate audio sequences; and
identifying a subset of the set of candidate audio sequences having at least a portion with characteristics of the selected musical attribute most similar to the audio sequence.

10. A non-transitory computer-readable storage medium including instructions stored thereon which, when executed by at least one processor, cause the at least one processor to:
receive an input including an audio sequence and a request to determine similar audio sequences to the audio sequence from a pre-processed audio catalog;
analyze the audio sequence to generate audio embeddings for the audio sequence at different time resolutions;
query a pre-processed audio catalog to retrieve audio embeddings for catalog audio sequences at the different time resolutions;
generate a set of candidate audio sequences from the pre-processed audio catalog based on comparing the audio embeddings for the audio sequence with the audio embeddings for the catalog audio sequences at the different time resolutions; and
provide the set of candidate audio sequences.

11. The non-transitory computer-readable storage medium of claim 10, wherein to analyze the audio sequence to generate the audio embeddings for the audio sequence at the different time resolutions, the instructions, when executed, further cause the at least one processor to:
extract a first set of audio embeddings for the audio sequence at a first resolution; and
combine the extracted first set of audio embeddings to generate a second set of audio embedding for the audio sequence at a second resolution, the second resolution longer than the first resolution.

12. The non-transitory computer-readable storage medium of claim 10, wherein to generate the set of candidate audio sequences from the pre-processed audio catalog based on comparing the audio embeddings for the audio sequence with the audio embeddings for the catalog audio sequences at the different time resolutions, the instructions, when executed, further cause the at least one processor to:
generate a first set of candidate audio sequences based on comparing the audio embeddings for the audio sequence with song-level audio embeddings from a first search index for audio sequences in the pre-processed audio catalog;
generate a second set of candidate audio sequences based on comparing the audio embeddings for the audio sequence with section-level audio embeddings from a second search index for the first set of candidate audio sequences; and
generate the set of candidate audio sequences by ranking the second set of candidate audio sequences based on their similarity to the audio sequence.

13. The non-transitory computer-readable storage medium of claim 10, wherein to provide the set of candidate audio sequences, the instructions, when executed, further cause the at least one processor to:
display the set of candidate audio sequences in a user interface; and
for each candidate audio sequence in the set of candidate audio sequences,
highlight at least a portion of the candidate audio sequence closest in similarity to the audio sequence, and
set a playhead at a starting timecode of the portion of the candidate audio sequence closest in similarity to the audio sequence.

14. The non-transitory computer-readable storage medium of claim 10, wherein the instructions, when executed, further cause the at least one processor to:
generate the pre-processed audio catalog by:
receiving the catalog audio sequences from an audio catalog; and
for each catalog audio sequence of the catalog audio sequences from the audio catalog,
extracting a first set of audio embeddings for the catalog audio sequence at a first fixed time resolution,
combining neighboring audio embeddings of the extracted first set of audio embeddings to generate a second set of audio embeddings for the catalog audio sequence at a second fixed time resolution, wherein the second fixed time resolution is longer than the first fixed time resolution, and
storing the first set of audio embeddings and the second set of audio embeddings in the pre-processed audio catalog.

15. The non-transitory computer-readable storage medium of claim 14, wherein to combine the neighboring audio embeddings of the extracted first set of audio embeddings, the instructions, when executed, further cause the at least one processor to:
average the neighboring audio embeddings at the first fixed time resolution to generate the second set of audio embeddings for the catalog audio sequence at the second fixed time resolution, wherein the second fixed time resolution is larger than the first fixed time resolution.

16. The non-transitory computer-readable storage medium of claim 10, wherein the instructions, when executed, further cause the at least one processor to:
generate the pre-processed audio catalog by:
receiving the catalog audio sequences from an audio catalog; and
for each catalog audio sequence of the catalog audio sequences from the audio catalog,
applying an automatic audio sectioning algorithm to segment the catalog audio sequence into self-consistent musical sections,
extracting a first set of audio embeddings for the catalog audio sequence at a first fixed time resolution,
combining neighboring audio embeddings of the extracted first set of audio embeddings to generate a second set of audio embeddings for the catalog audio sequence of variable length resolutions based on the self-consistent musical sections, and
storing the first set of audio embeddings and the second set of audio embeddings in the pre-processed audio catalog.

17. The non-transitory computer-readable storage medium of claim 10, wherein to analyze the audio sequence to generate the audio embeddings for the audio sequence, the instructions, when executed, further cause the at least one processor to:
determine characteristics of musical attributes of the audio sequence, the musical attributes of the audio sequence including mood, genre, tempo, and instruments.

18. The non-transitory computer-readable storage medium of claim 17, wherein to generate the set of candidate audio sequences from the pre-processed audio catalog based on the audio embeddings for the audio sequence, the instructions, when executed, further cause the at least one processor to:
receive a selection of a musical attribute for filtering the set of candidate audio sequences; and
identify a subset of the set of candidate audio sequences having at least a portion with characteristics of the selected musical attribute most similar to the audio sequence.

19. A system, comprising:
a computing device including a memory and at least one processor, the computing device implementing an audio recommendation system,
wherein the memory includes instructions stored thereon which, when executed, cause the audio recommendation system to:
receive an input including an audio sequence and a request to determine similar audio sequences to the audio sequence from a pre-processed audio catalog;
analyze the audio sequence to generate audio embeddings for the audio sequence at different time resolutions;
query a pre-processed audio catalog to retrieve audio embeddings for catalog audio sequences at the different time resolutions;
generate a set of candidate audio sequences from the pre-processed audio catalog based on comparing the audio embeddings for the audio sequence with the audio embeddings for the catalog audio sequences at the different time resolutions; and
provide the set of candidate audio sequences.

20. The system of claim 19, wherein the instructions to generate the set of candidate audio sequences from the pre-processed audio catalog based on comparing the audio embeddings for the audio sequence with the audio embeddings for the catalog audio sequences at the different time resolutions, further cause the audio recommendation system to:
generate a first set of candidate audio sequences based on comparing the audio embeddings for the audio sequence with song-level audio embeddings from a first search index for audio sequences in the pre-processed audio catalog;
generate a second set of candidate audio sequences based on comparing the audio embeddings for the audio sequence with section-level audio embeddings from a second search index for the first set of candidate audio sequences; and
generate the set of candidate audio sequences by ranking the second set of candidate audio sequences based on their similarity to the audio sequence.
